(19) United States
(12) Patent Application Publication
(10) Pub. No.: US 2024/0083018 A1
(43) Pub. Date: Mar. 14, 2024

(54) Muscle Assisting Device

(71) Applicants: Hyundai Motor Company, Seoul (KR); Kia Corporation, Seoul (KR)

(72) Inventors: Hyo-Joong Kim, Suwon-si (KR); Sang In Park, Suwon-si (KR); Ki Hyeon Bae, Hwaseong-si (KR); Ju Young Yoon, Suwon-si (KR); Beom Su Kim, Yongin-si (KR); Min Woong Jeung, Seoul (KR); Seong Taek Hwang, Suwon-si (KR); Ho Jun Kim, Gunpo-si (KR); Hyun Seop Lim, Anyang-si (KR); Kyu Jung Kim, Seoul (KR)

(21) Appl. No.: 18/166,667

(22) Filed: Feb. 9, 2023

(30) Foreign Application Priority Data
Sep. 14, 2022 (KR) 10-2022-0115871

(51) Int. Cl. B25J 9/00; A61H 3/00

(52) U.S. Cl. CPC B25J 9/0006; A61H 3/00; A61H 2201/165

(57) ABSTRACT

An embodiment device includes an input module including a motor configured to generate a rotational force, an output module configured to receive power from the input module to be rotatable, and a connection module having a first side coupled to the input module and a second side, opposite the first side, coupled to the output module, wherein the connection module is configured to transmit the power from the input module to the output module.

### CROSS-REFERENCE TO RELATED APPLICATIONS

This application claims the benefit of Korean Patent Application No. 10-2022-0115871, filed on Sep. 14, 2022, which application is hereby incorporated herein by reference.

### TECHNICAL FIELD

The present disclosure relates to a muscle assisting device.

### BACKGROUND

A waist muscle assisting device that may assist muscular forces of the waist of a person when the person is working generates a torque by elasticity in the vicinity of a rotatable joint of a human body, such as a hip joint, to alleviate a load applied to the waist of the person and the like in a work process.

The waist muscle assisting devices largely include an active type that provides a force that may assist muscular forces through a power source, such as a motor, and a passive type that provides a force that may assist muscular forces according to a posture of a user without using a separate power source. Among them, the active type waist muscle assisting device assists muscular forces of the waist of the user by providing a rotational force of a motor to a structure provided in the waist muscle assisting device.

Meanwhile, according to a conventional technology, the active type waist muscle assisting device is configured be provided in a structure provided in the waist muscle assisting device simply by using a rotational force of a motor, and thus an output of the motor has to become higher to assist muscular forces of the waist more. This causes an increase in costs for manufacturing the waist muscle assisting device and a volume of the waist muscle assisting device.

### SUMMARY

The present disclosure relates to a muscle assisting device. Particular embodiments relate to a muscle assisting device that may assist muscular forces of the waist of a user.

Embodiments of the present disclosure can solve problems occurring in the prior art while advantages achieved by the prior art are maintained intact.

An embodiment of the present disclosure provides a waist muscle assisting device that may significantly assist muscular forces of the waist of a wearer while employing a motor having a relatively low output.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a muscle assisting device for assisting muscles of a wearer includes an input module including a motor that generates a rotational force, an output module that receives power from the input module to be rotatable, a connection module, one side of which is coupled to the input module and an opposite side of which is fixed to the output module, and that transmits the power from the input module to the output module, and a main fixing member, to which the one side of the connection module is fixedly coupled and which is fixed to one side of the wearer. The connection module includes an elastic member that is elastically deformed as the output module is rotated with respect to the main fixing member, and the elastic member is elastically deformed to apply a force in a second direction that is an opposite direction to a first direction when the output module is rotated in the first direction with respect to the main fixing member before the elastic member is deformed.

The elastic member may have a through-hole in a middle area, the connection module may include an inner fixing member inserted into the through-hole of the elastic member and to which one side of the elastic member is fixed and an outer fixing member that faces an outer circumference of the elastic member and to which an opposite side of the elastic member is fixed. The inner fixing member may be fixedly coupled to the output module, and the outer fixing member is fixedly coupled to the main fixing member.

The elastic member may be a clockwork spring, an end of the clockwork spring may be fixed to the inner fixing member, and an opposite end of the clockwork spring may be fixed to the outer fixing member.

The input module may include a first pulley connected to a rotary shaft of the motor and that is rotated together with the rotary shaft, a second pulley spaced apart from the first pulley and connected to the inner fixing member to be rotatable together with the inner fixing member, and a belt member connecting the first pulley and the second pulley to surround the first pulley and the second pulley, and that transmits a rotational force of the first pulley to the second pulley.

The connection module may be spaced apart from the motor in a radiation direction of the motor and is provided in a widthwise direction of the motor.

A rotation center axis of the connection module may be formed in parallel to a rotary shaft of the motor.

A radius of curvature of the belt member in an area in which the belt member surrounds the second pulley, may be larger than a radius of curvature of the belt member in an area in which the belt member surrounds the first pulley.

The connection module may be provided on an upper side of the motor.

The output module may include a reducer, one side of which is fixedly coupled to the inner fixing member and that receives a rotational force from the inner fixing member, reduces the rotational force, and outputs the rotational force, and a rotary member fixedly coupled to one side of the reducer and that receives the rotational force reduced by the reducer to be rotated.

The main fixing member may be fixed relatively to a thigh of the wearer, and the rotary member may be fixed relatively to an upper body of the wearer

The first direction may be a direction in which the wearer bends the upper body.

A muscle assisting device may further include a connection shaft passing through a rotation center axis of the second pulley, a rotation center axis of the inner fixing member, and a rotation center axis of the reducer, and connecting the second pulley, the inner fixing member, and the reducer.

A muscle assisting device may further include a motor accommodating member coupled to one side of the main fixing member, an interior space may be defined by the main fixing member and the motor accommodating member, and the motor and the first pulley may be accommodated in the interior space defined by the main fixing member and the motor accommodating member.

The rotary member may be coupled to one side of the main fixing member, an interior space may be defined by the main fixing member and the rotary member, and the second pulley, the connection module, and the reducer are accommodated in the interior space defined by the main fixing member and the rotary member.

The rotation center axis of the reducer in an output area may be formed on a concentric axis to the connection shaft.

A muscle assisting device may further include a motor encoder spaced apart from the rotary shaft of the motor in a direction in which the rotary shaft extends and that senses the rotary shaft, and the motor encoder may face the motor while the first pulley is interposed therebetween.

A muscle assisting device may further include a connection shaft encoder surrounding a radially outer side of the connection shaft and that senses the connection shaft, and the connection shaft may further include a magnet member.

A muscle assisting device may further include a thigh pad being attachable to a front surface of the thigh of the wearer, and a lower connection member connecting the main fixing member and the thigh pad.

A muscle assisting device may further include an upper body pad being attachable to a front area of an upper body of the wearer, and an upper connection member connecting the rotary member and the upper body pad.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a front view illustrating a state in which a wearer wears a muscle assisting device according to embodiments of the present disclosure;

FIG. 2 is a perspective view illustrating a muscle assisting device according to embodiments of the present disclosure; and

FIG. 3 is an exploded perspective view illustrating an input module, an output module, and a connection module of a muscle assisting device according to embodiments of the present disclosure.

### DETAILED DESCRIPTION OF ILLUSTRATIVE EMBODIMENTS

Hereinafter, a muscle assisting device according to embodiments of the present disclosure will be described with reference to the drawings.

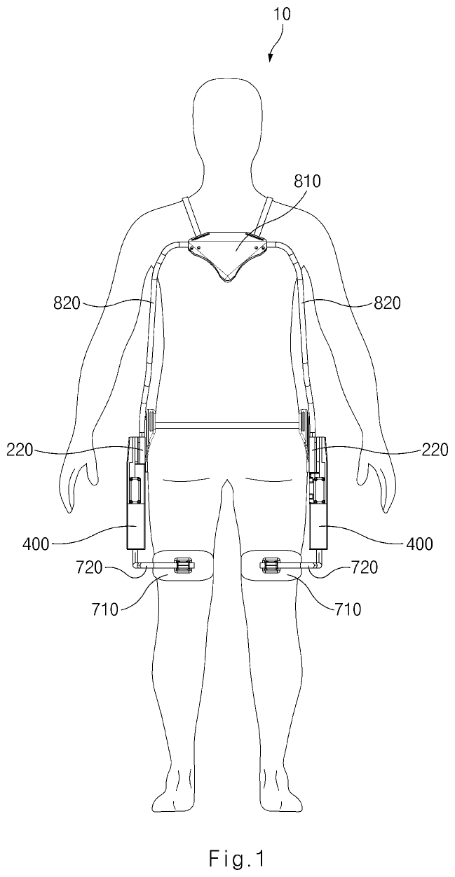

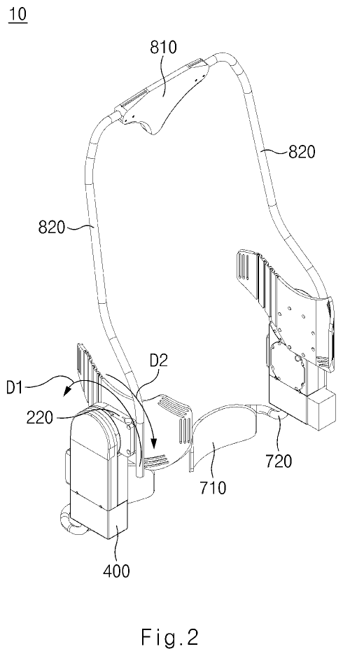

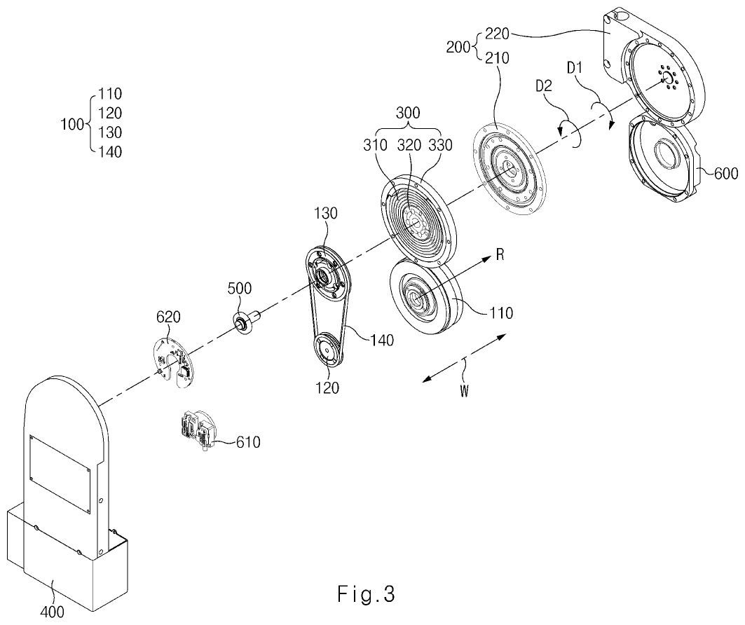

FIG. 1 is a front view illustrating a state in which a wearer wears a muscle assisting device according to embodiments of the present disclosure. FIG. 2 is a perspective view illustrating the muscle assisting device according to embodiments of the present disclosure. FIG. 3 is an exploded perspective view illustrating an input module, an output module, and a connection module of the muscle assisting device according to embodiments of the present disclosure.

Referring to the drawings, the muscle assisting device according to embodiments of the present disclosure is adapted to assist waist muscles of the wearer. In more detail, the muscle assisting device according to embodiments of the present disclosure may be a configuration for assisting waist muscles that are necessary when the wearer performs an operation of unbending the waist.

In particular, as will be described below, the muscle assisting device according to embodiments of the present disclosure may store elastic energy when the wearer performs an operation of bending the waist, and may assist waist muscles that are necessary to unbend the waist of the wearer by using the above-described elastic energy when the wearer performs an operation of unbending the waist. Accordingly, according to embodiments of the present disclosure, a volume of a motor that generates an assistant force for assisting muscular forces by the muscle assisting device may be reduced, and a higher assistant force may be provided as compared with a case in which a motor of the same output is mounted.

As illustrated in FIGS. 1 to 3, a muscle assisting device 10 according to embodiments of the present disclosure is a muscle assisting device for assisting muscular forces of a wearer and may include an input module wo including a motor no that generates a rotational force, an output module 200 that receives power from the input module 100 to be rotatable, and a connection module 300, one side of which is coupled to the input module 100 and an opposite side of which is fixed to the output module 200, and which transmits power from the input module 100 to the output module 200.

Furthermore, the muscle assisting device 10 may further include a main fixing member 400, to which the one side of the connection module 300 is fixedly coupled and which is fixed to one side of the wearer. The muscle assisting device 10 according to embodiments of the present disclosure may be a configuration for assisting waist muscles that are necessary when the wearer performs an operation of unbending the waist. As illustrated in FIGS. 1 and 2, the main fixing member 400 may be fixed relatively to a thigh of the wearer. That is, it may be construed that an aspect that the main fixing member 400 may be fixed relatively to the thigh of the wearer means that the main fixing member 400 is directly attached and fixed to the thigh of the wearer and that a relative location between the main fixing member 400 and the wearer is not changed regardless of an operation of bending or unbending the waist of the wearer.

In more detail, as illustrated in FIGS. 1 and 2, the muscle assisting device 10 may further include a thigh pad 710 that is attachable to a front surface of the thigh of the wearer and a lower connection member 720 that connects the main fixing member 400 and the thigh pad 710. That is, because the thigh pad 710 is attached to the thigh of the wearer, the main fixing member 400 connected to the thigh pad 710 through the lower connection member 720 may be fixed relatively to the thigh of the wearer. As illustrated in FIGS. 1 and 2, the lower connection member 720 may have a wire shape having a specific stiffness. Accordingly, the shape may be reversely deformed when an external force is applied to the lower connection member 720. Accordingly, when the wearer wears the muscle assisting device 10, the muscle assisting device 10 may be flexibly deformed according to a body shape of the wearer. Meanwhile, it may be understood that an aspect that the lower connection member 720 has a wire shape having a specific stiffness is contrasted with a case in which a shape of a thread, a rubber member, or the like is deformed while not enduring a weight thereof, that is, a self-weight thereof.

The output module 200 may be rotatable with respect to the main fixing member 400. It may be understood that rotation of the output module 200 with respect to the main fixing member 400 is rotation thereof that is made to correspond to a motion of the upper body of the user when the wearer who wears the muscle assisting device 10 performs an operation of bending or unbending the waist. As will be described below, the output module 200 may be directly coupled to the main fixing member 400 through a rotary member 220.

Meanwhile, according to embodiments of the present disclosure, the connection module 300 may include an elastic member 310 that is elastically deformed as the output module 200 is rotated with respect to the main fixing member 400. That is, the elastic member 310 may store elastic energy due to elastic deformation by rotation of the output module 200 with respect to the main fixing member 400 and then discharge the elastic energy.

In more detail, when the output module 200 is rotated in a first direction D1 with respect to the main fixing member 400 before the elastic member 310 is deformed, the elastic member 310 may be elastically deformed to apply a force in a second direction D2 that is an opposite direction to the first direction D1. For example, when the output module 200 is rotated in the first direction D1 with respect to the main fixing member 400, the elastic member 310 may be compressed, and accordingly, the elastic member 310 may store elastic energy due to elastic compressive deformation. Thereafter, when the output module 200 is rotated in the second direction D2 that is an opposite direction to the first direction D1 with respect to the main fixing member 400, the elastic member 310 may be deformed such that the elastic member 310 is brought into a state in which it is not deformed, and accordingly, the elastic member 310 may provide a rotational force in a direction in which the muscular forces of the waist of the wearer are assisted, while discharging the elastic energy stored due to the elastic compressive deformation. However, unlike the above description, when the output module 200 is rotated in the first direction D1 with respect to the main fixing member 400, the elastic member 310 may be stretched. However, according to a preferred embodiment of the present disclosure, even in this case, the elastic member 310 has to be elastically deformed to apply a force to the output module 200 in the second direction D2.

In more detail, according to embodiments of the present disclosure, the first direction D1 may be a direction in which the wearer who wears the muscle assisting device 10 bends the waist, that is, a rotational direction when the upper body is moved in a direction in which it is bent, and the second direction D2 may be a direction in which the wearer who wears the muscle assisting device 10 unbends the waist, that is, a rotational direction when the upper body is moved in a direction in which it is unbent. Accordingly, according to embodiments of the present disclosure, the elastic member 310 stores elastic energy when the wearer performs an operation of bending the waist, and the elastic member 310 discharges the stored elastic energy when the wearer performs an operation of unbending the waist. That is, according to embodiments of the present disclosure, because a power provided by the elastic member 310 in addition to the power provided by the motor no may assist a force that is necessary to unbend the waist of the wearer, the muscular forces of the waist of the wearer may be assisted further.

Hereinafter, referring to FIG. 3, a detailed configuration of the connection module 300 will be described in detail.

A through-hole may be formed in a middle area of the elastic member 310 provided in the connection module 300.

Then, the connection module 300 may further include an inner fixing member 320 inserted into the through-hole of the elastic member 310 and to which one side of the elastic member 310 is fixed, and an outer fixing member 330, which faces an outer circumference of the elastic member 310 and to which an opposite side of the elastic member 310 is fixed. As an example, the elastic member 310, as illustrated in FIG. 3, may be a clockwork spring, an end of the clockwork spring may be fixed to the inner fixing member 320, and an opposite end of the clockwork spring may be fixed to the outer fixing member 330. However, unlike the illustration of FIG. 3, the elastic member 310 may be a rubber member having elasticity. However, when the output module 200 is rotated in the first direction D1 with respect to the main fixing member 400, the rubber member may be stretched. Meanwhile, in the specification, a case in which the elastic member 310 has a shape of a clockwork spring will be mainly described.

Furthermore, the inner fixing member 320 may be fixedly coupled to the output module 200, and the outer fixing member 330 may be fixedly coupled to the main fixing member 400. As described above, the main fixing member 400 may be fixed relatively to the thigh of the wearer, and the output module 200 may be rotatable with respect to the main fixing member 400. Accordingly, when the output module 200 is rotated as the wearer performs an operation of bending or unbending the waist, a relative rotation occurs between the inner fixing member 320 fixedly coupled to the output module 200 and the outer fixing member 330 fixedly coupled to the main fixing member 400. Accordingly, a relative rotation occurs between one end of the elastic member 310 fixed to the inner fixing member 320 and an opposite end of the elastic member 310 fixed to the outer fixing member 330, whereby the shape of the elastic member 310 is deformed. The contents on storing and discharging elastic energy due to deformation of the shape of the elastic member 310 have been described above, and thus will not be repeated.

Referring now to FIG. 3, the input module 100 may include a first pulley 120 that is connected to a rotary shaft of the motor no and is rotated together with the rotary shaft, a second pulley 130 that is spaced apart from the first pulley 120 and is connected to the inner fixing member 320 to be rotatable together with the inner fixing member 320, and a belt member 140 that connects the first pulley 120 and the second pulley 130 to surround the first pulley 120 and the second pulley 130 and transmits a rotational force of the first pulley 120 to the second pulley 130. Accordingly, a rotational force of the motor no may be transmitted to the inner fixing member 320 via the first pulley 120, the belt member 140, and the second pulley 130. As an example, the first pulley 120 may be directly connected to a rotary shaft of the motor 110, and the second pulley 130 may be directly connected to the inner fixing member 320.

In more detail, the connection module 300 may be spaced apart from the motor 110 in a radial direction of the motor no and may be provided in a widthwise direction “W” of the motor 110. In this case, an overall volume occupied by the connection module 300 in the muscle assisting device 10 may be minimized.

Furthermore, a rotation center axis of the connection module 300 may be formed in parallel to the rotary shaft of the motor 110. It may be understood that the rotation center axis of the connection module 300 is a rotation center axis of the inner fixing member 320 when the inner fixing member 320 connected to the second pulley 130 receives a rotational force to be rotated.

Meanwhile, the rotary shaft of the motor no is a configuration that may be rotated by 360 degrees, whereas a radius, by which the waist of a person may be rotated, is relatively limited. Accordingly, to efficiently use the power of the motor no while implementing rotation of the output module 200 corresponding to a rotational angle of the waist of a person, the rotational force of the motor no needs to be transmitted while the angular velocity is decelerated when the rotational force of the motor no having the rotary shaft of a high angular velocity is transmitted to the output module 200.

To achieve this, as illustrated in FIG. 3, a radius of curvature of the belt member 140 in an area in which the belt member 140 surrounds the second pulley 130 may be larger than a radius of curvature of the belt member 140 in an area in which the first pulley 120 is surrounded.

Meanwhile, as an example, as illustrated in FIG. 3, the connection module 300 may be provided on an upper side of the motor 110. However, unlike this, the connection module 300 may be provided on a lower side of the motor 110.

Referring now to FIG. 3, the output module 200 may include a reducer 210, one side of which is fixedly coupled to the inner fixing member 320 and which receives a rotational force from the inner fixing member 320, reduces the rotational force, and outputs the rotational force, and the rotary member 220 fixedly coupled to one side of the reducer 210 and which receives the rotational force reduced by the reducer 210 to be rotated. The reducer 210 may be a configuration for additionally reducing the rotational force primarily reduced by the first pulley 120, the second pulley 130, and the belt member 140. Furthermore, the rotary member 220 may be provided to be fixed relatively to the upper body of the wearer. Accordingly, as the wearer performs an operation of bending or unbending the waist, the rotary member 220 also may be rotated with respect to the main fixing member 400 in correspondence to the upper body of the wearer. As the rotary member 220 is rotated with respect to the main fixing member 400, the shape of the elastic member 310 also may be changed, and accordingly, the elastic member 310 may store elastic energy through elastic compressive deformation or may discharge elastic energy while being restored to an original state.

Meanwhile, the reducer 210 may include a reducer input shaft that is directly connected to the inner fixing member 320 to be rotatable together with the inner fixing member 320 and a reducer output shaft that receives a rotational force from the reducer input shaft to output the rotational force while the rotational force is reduced. The reducer output shaft may be connected to the rotary member 220, and the rotary member 220 may be rotated at the same rotational angular speed as the rotational angular speed of the reducer output shaft. For example, the reducer 210 may be a planetary gear reducer and a harmonic reducer. Description of configurations and operational principles of the planetary gear reducer and the harmonic reducer will be replaced by conventionally known contents.

Referring now to FIG. 3, the muscle assisting device 10 may further include a connection shaft 500 that passes through a rotation center axis of the second pulley 130, a rotation center axis of the inner fixing member 320, and a rotation center axis of the reducer 210, and connecting the second pulley 130, the inner fixing member 320, and the reducer 210. In more detail, the second pulley 130, the inner fixing member 320, and the reducer input shaft may be fixedly coupled to the connection shaft 500. Accordingly, rotational speeds of the second pulley 130, the inner fixing member 320, and the reducer input shaft may be the same. Furthermore, as an example, a rotation center axis of the output shaft of the reducer may be formed on the same axis as that of the connection shaft 500.

Meanwhile, the motor no and the first pulley 120, which have been described above, may be accommodated in the interior space of the muscle assisting device 10. In this case, the motor no and the first pulley 120 may be in a closed state while not being exposed to the outside. To achieve this, referring to FIG. 3, the muscle assisting device 10 may further include a motor accommodating member 600 that is coupled to one side of the main fixing member 400. Then, an interior space may be defined by the main fixing member 400 and the motor accommodating member 600, and the motor no and the first pulley 120 may be accommodated in the interior space defined by the main fixing member 400 and the motor accommodating member 600.

Similarly to the motor no and the first pulley 120, the second pulley 130, the connection module 300, and the reducer 210 also may be accommodated in the interior space of the muscle assisting device 10. To achieve this, referring to FIG. 3, the rotary member 220 may be coupled to one side of the main fixing member 400, and an interior space may be defined by the main fixing member 400 and the rotary member 220. Then, the second pulley 130, the connection module 300, and the reducer 210 may be accommodated in the interior space defined by the main fixing member 400 and the rotary member 220. Meanwhile, as an example, as illustrated in FIGS. 2 and 3, the motor no and the first pulley 120 may be partitioned from the second pulley 130, the connection module 300, and the reducer 210 by the motor accommodating member 600 and the rotary member 220.

Referring now to FIG. 3, the muscle assisting device 10 may further include a motor encoder 610 which is spaced apart from the rotary shaft of the motor no in a direction in which the rotary shaft extends, and that senses the rotary shaft, and a connection shaft encoder 620 that surrounds a radially outer side of the connection shaft 500, and that senses the connection shaft 500. According to embodiments of the present disclosure, rotational angles of the motor no and the connection shaft 500 may be sensed through the motor encoder 610 and the connection shaft encoder 620, and accordingly, rotational angles of the motor no and the connection shaft 500 may be controlled. As an example, as illustrated in FIG. 3, the motor encoder 610 may be configured to face the motor no while the first pulley 120 is interposed therebetween. Furthermore, the connection shaft 500 may further include a magnetic member, and the connection shaft encoder 620 may measure an intensity of a magnetic field of the magnet member to sense a rotational angle of the connection shaft 500. More preferably, the motor encoder 610 may be an incremental encoder, and the connection shaft encoder 620 may be an absolute encoder.

Referring now to FIGS. 1 and 2, the muscle assisting device 10 may further include an upper body pad 810 that is attachable to a front area of the upper body of the wearer and an upper connection member 820 that connects the rotary member 220 and the upper body pad 810. That is, because the upper body pad 810 is attached to the upper body (for example, the chest) of the wearer, the rotary member 220 connected to the upper body pad 810 through the upper connection member 820 may be fixed relatively to the upper body of the wearer.

An embodiment of the present disclosure may provide a waist muscle assisting device that may significantly assist muscular forces of the waist of a wearer while employing a motor having a relatively low output.

Although it is apparent that the present disclosure has been described with reference to the limited embodiments and the drawings, the present disclosure is not limited thereto, and the present disclosure may be variously carried out by an ordinary person in the art within the technical spirit of the present disclosure and the equivalent ranges of the claims.

What is claimed is:

1. A device comprising:
an input module comprising a motor configured to generate a rotational force;
an output module configured to receive power from the input module to be rotatable; and
a connection module having a first side coupled to the input module and a second side, opposite the first side, coupled to the output module, wherein the connection module is configured to transmit the power from the input module to the output module.

2. The device of claim 1, further comprising a main fixing member, wherein the first side of the connection module is fixedly coupled to the main fixing member, and wherein the main fixing member is fixable to one side of a wearer.

3. The device of claim 2, wherein the connection module comprises an elastic member configured to be elastically deformed as the output module is rotated with respect to the main fixing member, wherein the elastic member is configured to be elastically deformed to apply a force in a second direction that is an opposite direction to a first direction when the output module is rotated in the first direction with respect to the main fixing member before the elastic member is deformed.

4. The device of claim 3, wherein:
the elastic member comprises a through-hole in a middle area; and
the connection module comprises:
an inner fixing member inserted into the through-hole of the elastic member, fixed to a first side of the elastic member, and fixedly coupled to the output module; and
an outer fixing member facing an outer circumference of the elastic member, fixed to a second side of the elastic member opposite the first side, and fixedly coupled to the main fixing member.

5. The device of claim 4, wherein:
the elastic member comprises a clockwork spring;
a first end of the clockwork spring is fixed to the inner fixing member; and
a second end of the clockwork spring, opposite the first end, is fixed to the outer fixing member.

6. The device of claim 4, wherein the connection module is spaced apart from the motor in a radiation direction of the motor and is provided in a widthwise direction of the motor.

7. The device of claim 4, wherein a rotation center axis of the connection module is parallel to a rotary shaft of the motor.

8. The device of claim 1, wherein the connection module is on an upper side of the motor.

9. A device comprising:
an input module;
an output module configured to receive power from the input module to be rotatable;
a main fixing member fixable to one side of a wearer; and
a connection module having a first side coupled to the input module and fixedly coupled to the main fixing member and a second side, opposite the first side, coupled to the output module, wherein the connection module is configured to transmit the power from the input module to the output module, and wherein the connection module comprises:
an elastic member comprising a through-hole in a middle area, wherein the connection module is configured to be elastically deformed as the output module is rotated with respect to the main fixing member and to be elastically deformed to apply a force in a second direction that is an opposite direction to a first direction when the output module is rotated in the first direction with respect to the main fixing member before the elastic member is deformed;
an inner fixing member inserted into the through-hole of the elastic member, fixed to a first side of the elastic member, and fixedly coupled to the output module; and
an outer fixing member facing an outer circumference of the elastic member, fixed to a second side of the elastic member opposite the first side, and fixedly coupled to the main fixing member; and
wherein the input module comprises:
a motor;
a first pulley connected to a rotary shaft of the motor and rotatable together with the rotary shaft;
a second pulley spaced apart from the first pulley and connected to the inner fixing member to be rotatable together with the inner fixing member; and
a belt member connecting the first pulley and the second pulley to surround the first pulley and the second pulley, wherein the belt member is configured to transmit a rotational force of the first pulley to the second pulley.

10. The device of claim 9, wherein a first radius of curvature of the belt member in a first area in which the belt member surrounds the second pulley is larger than a second radius of curvature of the belt member in a second area in which the belt member surrounds the first pulley.

11. The device of claim 9, wherein the output module comprises:
a reducer having a first side fixedly coupled to the inner fixing member, wherein the reducer is configured to receive a rotational force from the inner fixing member, reduce the rotational force, and output the rotational force; and
a rotary member fixedly coupled to a second side of the reducer and configured to receive the rotational force reduced by the reducer to be rotated.

12. The device of claim 11, wherein:
the main fixing member is fixable relatively to a thigh of the wearer; and
the rotary member is fixable relatively to an upper body of the wearer.

13. The device of claim 12, wherein the first direction is a direction in which the wearer bends the upper body.

14. The device of claim 12, further comprising:
a thigh pad attachable to a front surface of the thigh of the wearer; and
a lower connection member connecting the main fixing member and the thigh pad.

15. The device of claim 11, further comprising a connection shaft passing through a rotation center axis of the second pulley, a rotation center axis of the inner fixing member, and a rotation center axis of the reducer and connecting the second pulley, the inner fixing member, and the reducer.

16. The device of claim 15, wherein the rotation center axis of the reducer in an output area is on a concentric axis to the connection shaft.

17. The device of claim 15, further comprising a connection shaft encoder surrounding a radially outer side of the connection shaft and configured to sense the connection shaft, wherein the connection shaft comprises a magnet member.

18. The device of claim 11, wherein:
the rotary member is coupled to a first side of the main fixing member;
an interior space is defined by the main fixing member and the rotary member; and
the second pulley, the connection module, and the reducer are accommodated in the interior space defined by the main fixing member and the rotary member.

19. The device of claim 9, further comprising a motor accommodating member coupled to a first side of the main fixing member, wherein an interior space is defined by the main fixing member and the motor accommodating member, and wherein the motor and the first pulley are accommodated in the interior space defined by the main fixing member and the motor accommodating member.

20. The device of claim 9, further comprising a motor encoder spaced apart from the rotary shaft of the motor in a direction in which the rotary shaft extends and configured to sense the rotary shaft, wherein the motor encoder faces the motor while the first pulley is interposed therebetween.
